(19) United States
(12) Patent Application Publication
(10) Pub. No.: US 2009/0254896 A1
(43) Pub. Date: Oct. 8, 2009

(54) Simplifying Bundling Of Fixes Used To Resolve Errors In Pre-Installed Software

(75) Inventor: Thameem Ulla Khan, Bangalore (IN)

Correspondence Address: LAW FIRM OF NAREN THAPPETA, C/o Landon-IP Inc.,, 1700 Diagonal Road, Suite 450, Alexandria, VA, 22314, US

(73) Assignee: Oracle International Corporation, Redwood Shores, CA (US)

(21) Appl. No.: 12/099,157

(22) Filed: Apr. 8, 2008

(51) Int. Cl. G06F 9/44

(52) U.S. Cl. 717/169

(57) ABSTRACT

Simplifying the bundling of fixes used to resolve errors in pre-installed software. A user is first enabled to specify a list of fixes that are to be included in the bundle as a group. The availability of each of the list of fixes is then determined, with the fixes that are determined to be available being included in the bundle. An indication is provided to the user for the fixes that are determined to be not available.

### BACKGROUND

1. Technical Field

The present disclosure relates to software maintenance and more specifically to simplifying bundling of fixes used to resolve errors in pre-installed software.

2. Related Art

Pre-installed software represents software code/instructions already installed in a system. It is often observed that during the execution (or use) of the pre-installed software, various errors may be discovered. An error generally represents a deviation from a desired behavior of the software/system. The deviations can be in terms of desired/expected functionality, performance throughput, etc.

Vendors of pre-installed software often provide fixes to resolve such errors. A fix generally represents a portion of a software code that is used for resolving various errors. A fix is commonly used to replace data/instructions in the pre-installed software to resolve specific errors.

At least to simplify the transfer of desired fixes to locations where software is pre-installed, fixes are often grouped/provided together in the form of a bundle. Thus, bundles containing corresponding set of fixes may be provided for deployments with various instances of pre-installed software.

For example, the bundle of fixes may be generated and deployed periodically (e.g., every three months) to reduce the down time of the pre-installed software. Bundling may also be performed based on the type of errors, the manner of deployment of the fixes, security requirements for deployment, etc.

Various aspects of the present invention simplify bundling of fixes used to resolve errors in pre-installed software.

### BRIEF DESCRIPTION OF THE DRAWINGS

Example embodiments of the present invention will be described with reference to the accompanying drawings briefly described below.

FIG. 1 is a block diagram illustrating an example environment (computing system) in which several aspects of the present invention can be implemented.

FIG. 2 is a block diagram illustrating an example scenario in which bundling of fixes is performed in one embodiment.

FIG. 3 is a flowchart illustrating the manner in which the bundling of fixes is simplified according to an aspect of the present invention.

FIG. 4 depicts an interface using which an administrator/user may generate a bundle of fixes in one embodiment.

FIG. 5 depicts a portion of a status data indicating the availability of the fixes (by indicating the status of implementation of the corresponding projects) in one embodiment.

FIG. 6 depicts a portion of software code which depicts the logic underlying a bundler tool in one embodiment.

FIG. 7 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DESCRIPTION OF EXAMPLE EMBODIMENTS

### 1. Overview

According to an aspect of the present invention, the bundling of fixes used to resolve one or more errors in a software pre-installed in a (runtime) system is simplified. A user is first enabled to specify a list of fixes that are to be included in the bundle as a group. The availability of each of the list of fixes is then determined, with a first set of fixes that are determined to be available being included in the bundle. An indication to the user is provided for a second set of fixes that are determined to be not available.

In one embodiment, a status data indicating the availability of each of the fixes is maintained. The determination of the availability of each of the list of fixes is performed based on the status data.

According to another aspect of the present invention, the user specifies the list of fixes in the form of a table having multiple rows, with each row displaying a corresponding one of the list of fixes. In response, a (text/graphical) indication of whether the corresponding fix is available or not is displayed in each row. Thus, the table indicates the determined first and second sets of fixes.

In one embodiment, the table is contained in a user interface displayed on a display screen. The list of fixes is provided by the user by first receiving an identifier of each of the list of fixes in corresponding row of the table and then receiving an input representing a user selection of completion of providing the list of fixes. The determination of the availability of each of the list of fixes is performed in response to receiving the input.

Alternatively, an identifier of a file is received from the user, with the file containing the identifiers corresponding to the list of fixes. The list of fixes in the file is then displayed in the form of the table.

According to yet another aspect of the present invention, the first set of fixes are included in the bundle only when the first set of fixes is identical to the list of fixes. In other words, the bundle is generated only when all of the list of fixes (sought to be included in the bundle) are determined to be available (based on the status data).

According to one more aspect of the present invention, the status data includes information related to multiple projects, with each project representing an implementation of a corresponding fix. Each project is identified by a corresponding project name containing the identifier of the corresponding fix.

Accordingly, the determination of availability is performed by first checking whether the project name of each project contains the identifier of a fix and then concluding the fix to be available if there is at least one project with project name containing the identifier of the fix and that the fix is not available if there is no project with the project name containing the identifier of the fix.

In one embodiment, the status data is maintained in the form of a table. The inclusion of the fixes in the bundle is performed by inserting a project in the form of a corresponding row in the table for each of the first set of fixes. Each inserted row contains a bundle identifier identifying the bundle and an object identifier of an object sought to be modified by the fix, whereby all of the inserted rows contain the same bundle identifier.

A tool is then invoked, which creates the bundle containing the objects corresponding to the rows having the bundle identifier in the table.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, with other methods, or combining one more aspects/features described herein, etc. In other instances, well-known structures or operations are not shown in detail to avoid obscuring the features of the invention.

### 2. Example Environment

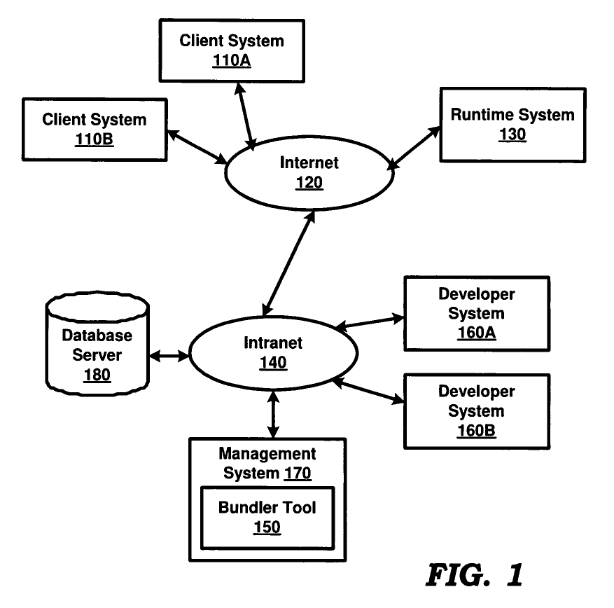

FIG. 1 is a block diagram illustrating an example environment (computing system) in which several aspects of the present invention can be implemented. The block diagram is shown containing client systems 110A-110B, internet 120, runtime system 130, intranet 140, developer systems 160A-160B, management system 170 (containing bundler tool 150), and database server 180.

Merely for illustration, only representative number/type of systems is shown in the Figure. Many environments often contain many more systems, both in number and type, depending on the purpose for which the environment is designed. Each system/device of FIG. 1 is described below in further detail.

Intranet 140 represents a network providing connectivity between developer systems 160A-160B, management system 170, and database server 180 (typically provided within the same enterprise). Internet 120 extends the connectivity of these with client systems 110A/110B and runtime system 130.

Each of intranet 140 and internet 120 may be implemented using protocols such as Internet Protocol (IP) well known in the relevant arts. In general, in IP environments, an IP packet is used as a basic unit of transport, with the source address being set to the IP address assigned to the source system from which the packet originates and the destination address set to the IP address of the target system to which the packet is to be eventually delivered.

Database server 180 represents a non-volatile storage facilitating storage and retrieval of a collection of data. Database server 180 may be used to store the details of the errors discovered during execution of the pre-installed software, the details of the corresponding fixes, data used in generating a specific bundle of fixes, etc.

In one embodiment, database server 180 is implemented using relational database technologies and therefore provides storage and retrieval of data using structured queries such as SQL (Structured Query Language). SQL refers to a special-purpose, non-procedural language that supports the definition, manipulation, and control of data in systems implementing relational database technologies

Each of client systems 110A-110B represents a system such as a personal computer, workstation, mobile station, etc., used by a user to generate (client) requests to pre-installed software applications executing in runtime system 130. The requests may be generated according to a suitable interface. In general, a client system requests an application for performing operations (to achieve desired tasks) and receives corresponding responses containing the results of performance of the requested operations.

Runtime system 130 represents a server, such as a web/application server, which executes pre-installed software applications capable of performing operations requested by client systems 110A-110B. Runtime system 130 may perform the operations on data maintained internally or on external data (for example, a data store not shown) and then send the results of performance of the operations as corresponding responses to the requesting client system.

It may be appreciated that during the performance of operations by the software applications pre-installed in the runtime system, various errors may be discovered. These errors may include logical errors (due to wrong logic), functional errors (due to the software not performing/functioning as expected), runtime errors (due to problems with the environment in which the software is executed), etc. As noted above, opportunities presenting performance improvements are also deemed as errors. Such errors (as well as any others detected) require changes to be made to the software instructions constituting the pre-installed software.

Several features of the present invention are described with respect to fixing errors in the software pre-installed on runtime system 130, merely for illustration. However, it should be appreciated that the features described below may be used to generate bundles (of corresponding fixes) for software pre-installed on other types of systems (including stand alone systems, server clusters, etc.), as will be apparent to one skilled in the relevant arts by reading the disclosure provided herein.

Each of developer systems 160A-160B enables developers/programmers (or users in general) to generate fixes used to resolve the errors in the pre-installed software in runtime system 130. The fixes typically contain elements such as software instructions, database schema changes, data used by the software applications, etc., which replace corresponding elements in the pre-installed software in runtime system 130.

As described above in the background section, the fixes may be deployed in the pre-installed software in the form of bundles (generated periodically or based on specific criteria). Accordingly, the developers may also maintain the fixes (or at least the status/location of the fixes) in database server 180, to facilitate bundling.

Management system 170 provided according to an aspect of the present invention simplifies the bundling of the fixes. In one embodiment, such features are operative by execution of software instructions constituting bundler tool 150, and accordingly the description below is provided with respect to bundler tool 150. However, it is helpful to first understand the general relationship between errors, fixes, and bundles.

### 3. Bundles in General

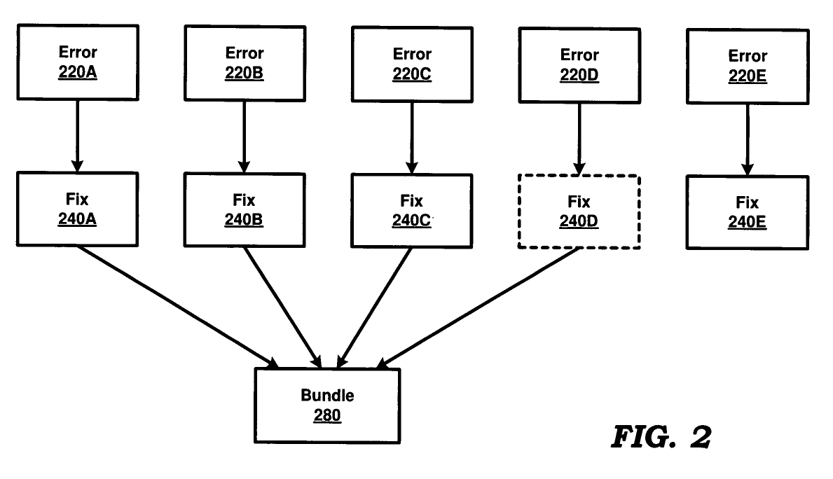

FIG. 2 is a block diagram illustrating an example scenario in which bundling of fixes is performed in one embodiment. The block diagram is shown containing errors 220A-220E, fixes 240A-240E, and bundle 280. Each of the blocks is described in detail below.

Each of errors 220A-220E represents a problem/error discovered in pre-installed software executing in runtime system 130. Each of errors 220A-220E may be associated with a unique error identifier, a short/detailed description, the steps performed when the error was discovered, a priority/severity etc. Though the details of the errors are not described herein for conciseness, it may be understood that each error has sufficient information to enable corresponding fixes to be developed by the developers.

Each of fixes 240A-240E is designed to resolve the respective errors 220A-220E. Fixes 240A-240E may be developed by different developers using developer systems 160A-160B, with each fix containing software instructions and/or data designed to modify the software code constituting the pre-installed software (executing in runtime system 130), thereby resolving the corresponding error. Each fix may also be associated with a unique fix identifier (typically the error identifier) to keep track of the fixes for bundling.

The description is continued assuming that each fix is designed to resolve a single error (one-to-one mapping) discovered in pre-installed software. However, the features described below can be extended for one-to-many, many-to-one, and many-to-many mappings between errors and fixes as will be apparent to one skilled in the relevant arts by reading the disclosure provided herein.

Bundle 280 is generated from a specific list of fixes (240A-240D). Bundle 280 may also contain other information such as the manner of deployment of each fix, the specific component/portion of the pre-installed software to which a corresponding fix is to be deployed, the specific order of deployment, etc.

It may be appreciated that the development of some of the fixes (such as 240D shown in dotted lines) may not be available when the bundle is to be generated. A fix may be unavailable due to various reasons such as non-completion of coding of the fix, failure of the developer to upload the fix to a common location etc. Accordingly, it may be necessary that during bundling, the availability of each of the list of fixes be determined.

In a prior approach, a user interface of a system enables a user to sequentially enter identifiers of each of the fixes sought to be added to a bundle. In response to entering of each identifier, the system checks the availability of the corresponding entered fix identifier in a database, and then enables the user to specify whether to include the corresponding fix in the bundle before enabling the user to enter the next identifier. The checking of availability and enabling user to specify whether to include the specified fix are repeated for each fix before permitting the user to enter the next fix identifier. The bundle is generated after the user indicates completion of entering identifiers of all desired fixes.

Further to requiring considerable time and/or resources, such a prior approach also requires the user/administrator to perform the tasks in a repetitive (and monotonous) manner, thereby increasing the possibility of committing mistakes (such as specifying incorrect error/fix identifier, missing fixes that are to be included in a bundle, etc.).

Thus, it may be desirable that the process of bundling fixes be simplified. An aspect of present invention simplifies the bundling of fixes by enabling a user to specify the list of fixes (sought to be include in a bundle) as a batch as described below with examples.

### 4. Simplifying Bundling of Fixes

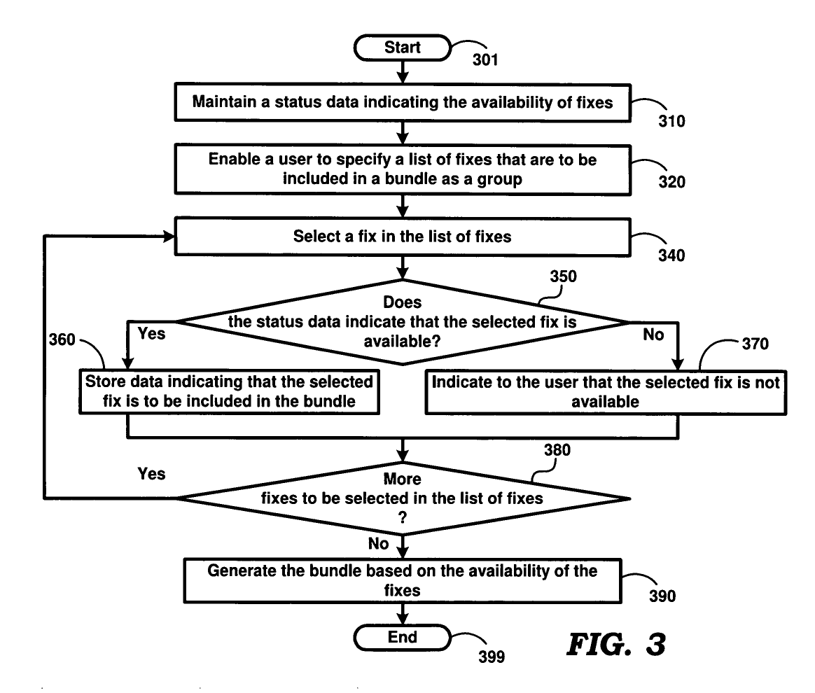

FIG. 3 is a flowchart illustrating the manner in which the bundling of fixes is simplified according to an aspect of the present invention. The flowchart is described with respect to FIGS. 1 and 2 merely for illustration. However, various features can be implemented in other environments also without departing from the scope and spirit of various aspects of the present invention, as will be apparent to one skilled in the relevant arts by reading the disclosure provided herein.

In addition, some of the steps may be performed in a different sequence than that depicted below, as suited in the specific environment, as will be apparent to one skilled in the relevant arts. Many of such implementations are contemplated to be covered by several aspects of the present invention. The flow chart begins in step 301, in which control immediately passes to step 310.

In step 310, a status data indicating the availability of fixes (for corresponding errors) is maintained. The status data may be maintained (by bundler tool 150) in database server 180 or in a local data store (not shown) associated with management system 170.

In one embodiment described below, a management tool executing in management system 170 enables developers to provide the details of the fixes/status of fixes for corresponding errors from one of developer systems 160A-160B. Management system 170 may track the status of various errors/fixes and provide desired related features, as in several products used in software development environments. The management tool then maintains the status data (along with other information required to generate the bundle) in database server 180.

Thus, in the example scenario shown in FIG. 2, the status data may indicate that the fixes 240A-240C and 240E are available and that fix 240D is not available.

In step 320, bundler tool 150 enables a user to specify a list of fixes (240A-240D) that are to be included in a bundle (280), as a group. Specifying as a group implies that the items of the list are specified together (e.g., as a single input). The list of fixes may be specified by a user/administrator using an appropriate interface. The interface may be provided on a display unit (not shown in FIG. 1) associated with management system 170 or developer systems 160A-160B. Alternatively, the identifiers of the list of fixes may be specified in a file, which may then be provided as an input to bundler tool 150.

As described below, the list of fixes thus specified, is processed in a batch mode (i.e., without requiring the user to interactively specify the elements sequentially thereafter).

In step 340, bundler tool 150 selects a fix in the list of fixes. The selection of the fix may be performed using different techniques as will be apparent to one skilled in the arts. In one technique, the fixes in the input data are selected in the same sequence as that specified by the list. Accordingly, the first fix (identifier) in the list (240A) is initially selected, followed by the second fix (240B), etc. until the final fix (240D) in the list is selected in step 340.

In another technique, each of the fixes is associated with a corresponding flag, with the value of the flag indicating whether the corresponding fix has been selected (value “T”) or not (value “F”). Thus, during the performance of step 340, fixes having a flag value of “F” are consecutively selected.

In step 350, bundler tool 150 determines whether the status data indicates that the selected fix is available. Bundler tool 150 may inspect the status data (maintained in database server 180 by the management tool) to determine whether the status of the selected fix identifier indicates that the selected fix is available. Alternatively, bundler tool 150 may check whether the data/software code constituting the selected fix is available (for example in database server 180).

Control passes to step 360 if the selected fix is determined to be available and to step 370 otherwise. Accordingly, in the above example scenario, control passes to step 360 when each of fixes 240A-240C is selected and to step 370 when fix 240D is selected.

In step 360, bundler tool 150 stores data indicating that the selected fix is to be included in the bundle (280) if the selected fix is determined to be available in step 350 (for example, when fixes 240A-240C are selected). The indication may be provided in any desirable/convenient manner.

In one embodiment described below, the fixes to be included in the bundle are indicated as corresponding rows in a pre-defined table in a database in database server 180. As such, the inclusion of the selected fix (and for each fix determined to be available) is performed by inserting a corresponding row in the table. Control then passes to step 380.

In step 370, bundler tool 150 indicates to the user that the selected fix (for example, when fix 240D is selected) is not available. The indication may be provided on a display unit (not shown) associated with management system 170 or developer systems 160A-160B. Alternatively, an output data containing the list of fixes and the corresponding availability status may be generated. Control then passes to step 380.

In step 380, bundler tool 150 checks whether there are more fixes to be selected in the list of fixes. The checking may be performed according to the manner of selection described above with respect to step 340. Thus, in the technique where the fixes are selected in the sequence specified by the list, bundler tool 150 may check whether the end of the list is reached (for example, by checking for a specific keyword indicating the end of the list).

Alternatively, in the technique where each of the fixes is associated with a corresponding flag, bundler tool 150 may first set the of the flag associated with the selected fix to the value “T” indicating that the fix has been selected. Bundler tool 150 may then check whether there exists at least one fix having a flag value of “F” (indicating the presence of unselected fixes).

Control passes to step 340, if bundler tool 150 determines that there are more fixes to be selected and to step 390 otherwise.

In step 390, the bundle is generated based on the availability of the fixes. The generation of the bundle containing the data/software code of the fixes may be performed by bundler tool 150 or any other suitable tool. In general, once the specific code/data (for the desired fixes) that is to be included in the bundle is identified, the bundle may be generated using one of several well known techniques. Thus, the bundle may be generated containing only the fixes that are indicated to be included in step 360.

In one embodiment described below, the bundle of fixes is generated only when all of the list of fixes (specified as a batch) are determined to be available and indicated for inclusion in the bundle (steps 350 and 360). In a scenario, that one of the fixes is determined to be not available, an indication of non-availability of the fix is displayed to the user, and the bundle is not generated. The flowchart ends in step 399.

Thus, bundler tool 150 receives a list of fixes (240A-240D) as a group and batch processes the list to generate a bundle (280), thereby simplifying the bundling of fixes. Due to such batch processing, the time and resources required to generate bundles may be considerably reduced.

It should be appreciated that the feature described above can be implemented in different types of embodiments. The manner in which an administrator/user is enabled to generate a bundle of fixes using a batch process is described below with examples.

### 5. Example Illustrating Bundling of Fixes

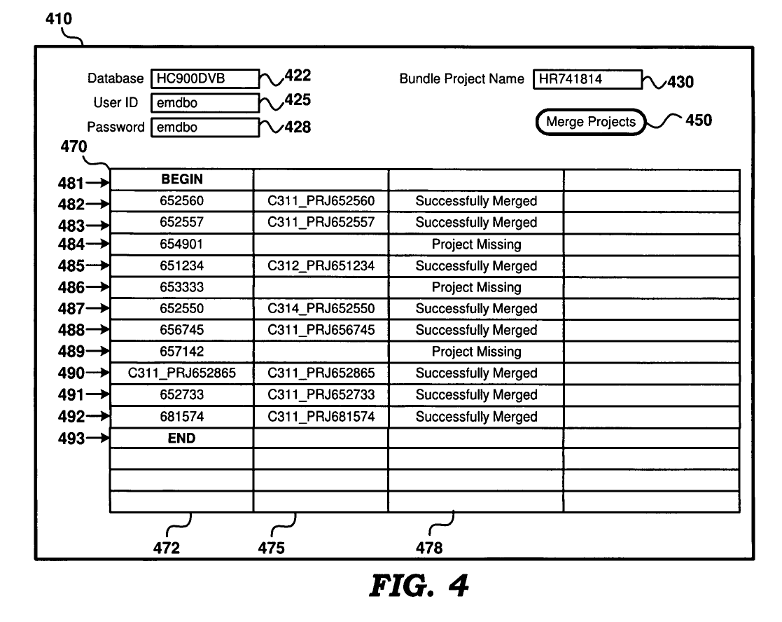

FIGS. 4, 5 and 6 together illustrate the manner in which an administrator/user is enabled to generate to bundle of fixes using a batch process in one embodiment. Each of the Figures is described in detail below.

FIG. 4 depicts an interface using which an administrator/user may generate a bundle of fixes in one embodiment. Display area 410 enables an administrator/user to indicate as a group a desired list of fixes sought to be included in a bundle. Display area 410 may represent a portion of a screen that may be displayed by bundler tool 150 on a display unit (not shown) associated with management system 170.

In one embodiment, each fix is implemented (by different developers) in the form of corresponding projects. Each project is provided a unique name by concatenating text “PRJ” with the corresponding fix identifier. Different versions of the same fix may be implemented (hereafter referred to as builds) with the build/version number (prefixed to the unique name) indicating the corresponding versions. The status of implementation of the projects (indicating the availability of the corresponding fixes) is maintained in pre-determined tables in a database in database server 180.

Accordingly, an administrator specifies the name of database (text field 422) maintaining the status of implementation of the projects corresponding to the fixes and also the authentication information (in the form of user name and password in text fields 425 and 428) required to access the database.

Text field 430 (labeled “Bundle Project Name”) indicates the name of the bundle “HR741814” to be generated. Button 450 (labeled “Merge Projects”) enables an administrator/user to indicate (by clicking/selecting the button) that the bundle of fixes is to be generated once the user has indicated the list of fixes as a group in table 470, as described below.

Table 470 depicts the details of the fixes sought to be included in the generated bundle. Table 470 is provided in the form of a spreadsheet containing a large number of rows and columns, though only the rows and columns relevant for describing various aspects of the invention are shown in the Figure for conciseness. Broadly, the data of column 472 is provided as input by a user, and bundler tool 150 updates the display with the information in columns 475 and 478, as described below in detail.

Column 472 depicts a list of fixes that are to be included in the generated bundle. It may be observed that each fix is identified by the fix's corresponding identifier or by the name of the corresponding project (as shown in row 490). While projects are generally specified to fix errors, some of the projects (e.g., that shown in row 490, where the project name itself is specified) may be included for other purposes, such as, to add a new feature to the preinstalled software executing in run-time system 130.

Further, the list of fixes is specified between the “BEGIN” and “END” keywords (as shown in rows 481 and 493) which respectively indicate the beginning and the end of the list. Thus, an administrator/user may first specify a desired list of fixes as a group between the keywords “BEGIN” and “END”, along with the details of accessing the database and the bundle name. The administrator/user may then click/select button 450 to batch process the list of fixes (sought to be included in the bundle).

Columns 475 and 478 represent output data generated by bundler tool 150 in response to receiving the input data to be batch processed. Column 475 specifies the name of the specific project (corresponding to a specific version of the fix) that has been identified by bundler tool 150 for inclusion in the bundle. Column 478 specifies the availability of the corresponding fix specified in the input data.

Each of rows 482-492 depicts the details of a fix sought to be included in the bundle. In particular, row 482 indicates a fix with unique identifier “652560” (column 472), whose corresponding project named “C311_PRJ652560” (column 475) has been included in the bundle (as indicated by the text “Successfully Merged” in column 478). Similarly rows 483, 485, 487-488 and 490-492 indicate fixes that have been included in the bundle (indicated by the name in text field 430).

Row 484 indicates a fix with unique identifier “654901”, whose corresponding project has been determined to be not available for inclusion in the bundle (as indicated by the text “Project Missing” in column 478). Similarly, rows 486 and 489 indicate fixes that have been determined to be not available for inclusion in the bundle.

Thus, the status of the availability of the fixes (sought to be included in the bundle) is provided to the administrator/user. In a scenario that all the fixes are indicated to be successfully included in the bundle, the administrator/user may execute an appropriate tool to generate the corresponding bundle. In one embodiment, the appropriate tool is programmatically invoked by bundler tool 150 in the scenario that all the fixes are indicated to be included in the bundle.

Alternatively, in a scenario that some of the fixes are indicated to be not available (missing), the administrator/user may contact the corresponding developer(s) (identifiable based on the project name) for the unavailable fixes.

Thus, the process of bundling (generating a bundle) of fixes is simplified. It may be appreciated that the availability of a fix/project may be determined in any suitable/convenient manner. In one embodiment, a status data indicating the availability of fixes is maintained as described below with examples.

### 6. Maintaining Status Data

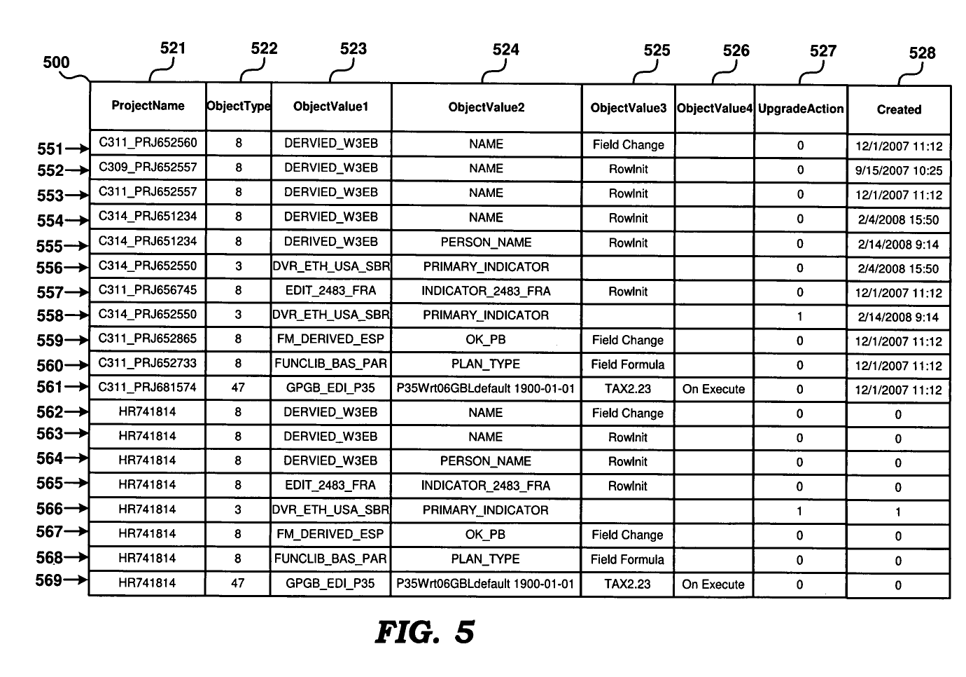

FIG. 5 depicts a portion of a status data indicating the availability of the fixes (by indicating the status of implementation of the corresponding projects) in one embodiment. The status data may be generated/updated by bundler tool 150 (or a management tool not shown) and may be maintained in a database (not shown) local to management system 170 or in database server 180.

Though only the information required for determining the availability of the fixes is shown as being maintained in status data, other information (such as the developers associated with a project, the create/update date, etc.) may also be maintained as will be apparent to one skilled in the relevant arts.

Table 500 specifies the details of various projects available for inclusion in bundles as well as the specific projects determined to be included in a present bundle being formed/processed.

Column 521 “ProjectName” indicates the name of each of the projects. Each project name, available for bundling, consists of the build/version number/identifier, followed by the text “_PRJ” and the unique identifier of the fix. The build numbers are specified in the format “C309”, “C311”, “C314” etc. with a higher value indicating a later version. On the other hand, the bundle name is used as “ProjectName” for projects determined to be included in the present bundle.

Columns 522-527 specify the information about the implementation of each of the project. In particular, column 522 (labeled “ObjectType”) indicates the type of the object (for example, webpage, repository object, etc) that has been modified as part of the project/fix. Columns 523 “ObjectValue1”, 524 “ObjectValue2”, 525 “ObjectValue3”, and 526 “ObjectValue4” indicate the specific values in the object that have been modified. Column 527 “UpgradeAction” indicates whether the object was updated (value “0”) or deleted (value “1”). Column 528 “Created” indicates the date/time when the corresponding row was inserted/created in table 500, thereby indicating the date/time when the corresponding fix was made available.

Each of rows 551-561 indicates the projects corresponding to the fixes available. In particular, row 551 indicates that that project named “C311_PRJ652560” has been implemented, with the implementation causing changes in a record (as indicated by the object type value “8”). The corresponding changes are indicated in columns 523-526 with the value “0” in column 527 indicating that the object was updated. The value “Dec. 1, 2007 11:12” indicate the date/time at which row 551 was inserted in the table. Similarly, rows 552-561 specify the details of other projects corresponding to the fixes.

It may be appreciated that only projects that have been implemented are contained in table 500. Thus, bundler tool 150 may determine the availability of a fix by searching for the presence of the identifier of the fix in the project name column (521). The fix may be determined to be available if table 500 contains at least one project whose project name contains the fix identifier and to be not available otherwise.

It may be observed that the status data indicates multiple projects corresponding to the same fix (e.g. rows 552 and 553). Further, some of the projects (having the same project name) are shown to differ only in the object values affected (e.g. rows 554 and 555) and/or the upgrade action performed on the object (e.g. 556 and 558). It may be desirable that such multiple projects corresponding to the same fix be merged during inclusion of the fix in the bundle.

In one embodiment, it is assumed that the latest project (having the more recent build number or created time) contains all the changes made in the previous projects. Accordingly, the merging of the multiple projects corresponding to the same fix is achieved by selecting the project with the latest build number or created time.

In the above example, the project “C311_PRJ652557” (in row 553) is selected for the fix “652557”, since the build number “C311” is higher than the build number “C309” of the project “C309_PRJ652557” (in row 552). For the projects “C314_PRJ651234” and “C314_PRJ652550” differing only in the object values affected (e.g. rows 554 and 555) and/or the update action performed (e.g. 556 and 558), the projects corresponding to the rows 555 and 558 are selected for having the latest created date/time (shown in row 528).

Thus, bundler tool 150 in response to receiving the list of fixes in a batch (as shown in column 472 of FIG. 4), first determines the (availability of the) projects corresponding to the fixes. Bundler tool 150 then selects a project for each of the fixes (based on the latest bundle number or created time) for inclusion in the bundle and indicates (by storing a corresponding data) that the selected projects are to be included in the bundle.

In one embodiment, the selected projects are indicated for inclusion in a bundle by inserting corresponding rows in table 500, with each row having the bundle name as the project name, with the values in the other columns being copied from the corresponding columns of the project sought to be included.

Each of rows 562-569 indicates the projects (and correspondingly the fixes) to be included in a bundle “HR741814”. Rows 562-569 correspond respectively to the projects depicted in rows 551, 553 (selected from 552 and 553), 555 (selected from 554 and 555), 557, 558 (selected from 556 and 558), 559, 560, and 561. It may be observed that the project name in rows 562-569 is indicated to be the bundle name “HR741814”, with the other details being similar to the details of the corresponding projects in the rows above.

It may be appreciated that the status data (indicating the availability of the fixes) and the bundle data (indicating the fixes to be included in a bundle) are shown to be maintained together in the same table (500). However, in alternative embodiments, the bundle data may be maintained independently (for example, as a different table/database, in a different format etc.). Further, the manner of including a fix in a bundle may be suitably chosen based on the specific environment in which the features of the invention are sought to be implemented.

Bundler tool 150 may now programmatically invoke a tool to generate the bundle “HR741814” containing the data/software instructions corresponding to the fixes/projects indicated to be included in the bundle. The implementation of programmatic invocation and/or the implementation of the tool to bundle will be apparent to one skilled in the relevant arts at least based on the disclosure provided herein.

Broadly, the tool to generate the bundle needs to be designed to identify the data/software portions (forming fixes) based on the combinations of the object type and the object values forming object identifiers (columns 522-526). The identification may be performed based on other data (not shown) related to the objects. The tool may then be required to provide the identified data/software portions in a form suitable for deployment on runtime system 130.

It should be appreciated that the bundler tool 150 can be implemented using various logics consistent with at least some of the features described above. The description is continued with respect to an example logic underlying the bundler tool.

### 7. Logic for Bundler Tool

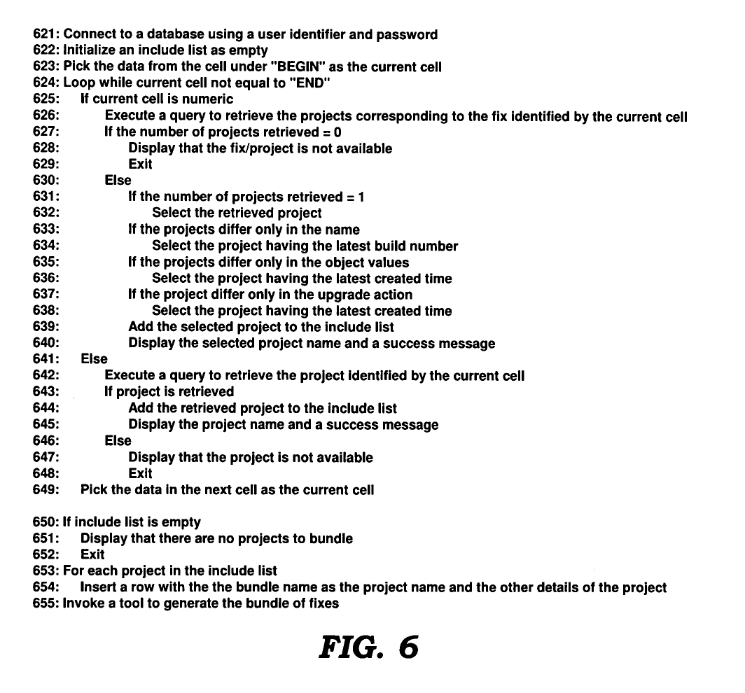

FIG. 6 depicts a portion of software code which depicts the logic underlying a bundler tool in one embodiment. For ease of understanding, the logic is depicted in the form of a pseudo-code. However, it should be appreciated that the bundler tool can be implemented using other logics and/or other types of programming languages, etc., as will be apparent to one skilled in the relevant arts by reading the disclosure provided herein.

The code described below may be executed on a user/administrator selecting/clicking button 450 (in FIG. 4). It is assumed that the input data containing the list of fixes (in column 472), the details of accessing the database (text fields 422, 425 and 428), and the name of the bundle sought to be created (text field 430) are made available to the software code in an appropriate manner.

In line 621, a connection is established with a database (specified in text field 422) using a user name and password (respectively specified in text fields 425 and 428). The manner of connecting to the database may be implemented in a known way.

In line 622, a variable named “include list” is initialized as empty. The variable “include list” keeps track of the projects to be include in the bundle. In line 623, the data from the cell under “BEGIN” in the list of fixes specified in column 472 (of table 470) is picked and stored in a variable named “current cell”. Thus, according to the data depicted in FIG. 4, the value of “652560” is stored in “current cell” after execution of line 623.

Lines 624-649 together form a loop which on execution causes the data from each of the cells in column 472 to be picked sequentially (as indicated by line 649) until the data matches the text “END” (as indicated by line 624). Thus, lines 625-648 are performed for each of the values specified in column 472.

In line 625, the value of the “current cell” is inspected to determine whether the value is numeric (indicating that that value represents a fix identifier). Lines 626-640 are executed if the current cell value is determined to be numeric and lines 642-648 are executed otherwise (in a scenario that the value is non-numeric, that is, represents a project identifier).

In line 626, a query is executed to retrieve the projects corresponding to the fix identified by the current cell (since the value in the current cell represents a fix identifier). The query to be executed may be formed based on the database to which connection is established.

In one embodiment, where the status data is maintained (as depicted in FIG. 5) in a database in database server 180, the query may be formed in SQL as follows:

SELECT *

FROM ProjectItems

WHERE ProjectName LIKE ‘% ID’

where
“SELECT”, “FROM”, “WHERE”, “LIKE”, “%”, “*” are keywords in SQL,
“*” indicates that all the columns in the table are to be retrieved,
“ProjectItems” is the name of the table storing the status data (table 500),
“ProjectName” is the name of column storing the project name (column 521), and
“ID” is the value of the current cell (fix identifier).

Thus, the execution of the above query causes the projects having the fix identifier in the corresponding project name to be retrieved.

In line 627, it is determined whether the number of projects retrieved by the query equals 0 (that is, whether there are projects corresponding to the fix identifier). Lines 628-629 are executed if there are no projects corresponding to the fix (indicating that the fix is not available) and lines 631-640 are executed otherwise.

In lines 628-629, an indication that the fix/project is not available is displayed and the execution of the code is stopped (due to the command “Exit” in line 629). Thus, in the scenario that the current cell has the value “654901” (shown in row 484) the text “Project Missing” is displayed in column 487 (as shown in FIG. 4) since the query status data does not contain any projects corresponding to the fix identifier, thereby causing no projects to be retrieved on execution of the query in line 626.

In lines 631-638, a project corresponding to the fix identifier is selected (for inclusion in the bundle). The retrieved project is selected if the only one project is retrieved by execution of the query (as shown in line 631-632). In a scenario that there are different projects (more than one) corresponding to a fix and the projects differ only in the project name, the project having the latest build number (contained in the project name) is selected (as shown in lines 633-634). For retrieved projects that differ only in the object values or upgrade action, the project with the latest created time is selected (as shown in lines 635-638).

Though shown separately, it may be appreciated that the logic depicted in lines 631-638 may be combined with the above query, as will be apparent to one skilled in the relevant arts.

In line 639, the selected project is added to the include list (for inclusion in the bundle). In line 640, the project name of the selected project and a success message are displayed. Thus, in the scenario, that the current cell has the value “652557”, the corresponding projects depicted in rows 552 and 553 may be retrieved on execution of the query. Since the retrieved projects differ only in the project name, the project with the latest build number “C311_PRJ652557” is selected in line 634 and added to the include list in line 639. In line 640, the name of the selected project and a success message “Successfully Merged” is displayed respectively in columns 475 and 478 as shown in FIG. 4.

Lines 642-648 are executed when the value of the current cell is non-numeric and represents a project identifier. Thus, in the example list of fixes shown in FIG. 4, lines 642-648 are executed when the value of the current cell is “C311_PRJ652865” (as depicted in row 490).

In line 642, a query is executed to retrieve the project identified by the current cell. In one embodiment described above, the query may be formed in SQL as follows:

SELECT *

FROM ProjectItems

WHERE ProjectName=‘ID’

where
“SELECT”, “FROM”, “WHERE”, “=”, “1” are keywords in SQL,
“*” indicates that all the columns in the table are to be retrieved,
“ProjectItems” is the name of the table storing the status data (table 500),
“ProjectName” is the name of column storing the project name (column 521), and
“ID” is the value of the current cell (fix identifier).

Thus, the execution of the above query causes the project having the project name similar to the identifier to be retrieved. In line 643, it is determined whether the project is retrieved, with lines 644-645 being executed if the project is retrieved and lines 647-648 otherwise.

In lines 644-645, the retrieved project is first added to the include list and then the project name and a success message are displayed similar to lines 639-640. In lines 647-648, an indication that the fix/project is not available is displayed and the execution of the code is stopped similar to lines 628-629 as described above.

Lines 650-655 are executed after all of the fixes in the list (specified as a batch) in column 472 have been processed. After the list has been processed, the variable “include list” contains the projects selected for inclusion in the bundle.

In line 650, the “include list” is inspected to determine whether the there are projects selected to be included in the bundle. Lines 651-652 are executed if the “include list” is empty (indicating that there no projects selected). In lines 651-652, a message indicating that there are no project to bundle is displayed and the code stops execution.

Lines 653-655 are executed when the include list contains projects to be included in the bundle. Lines 653-654 form a loop that is repeated for each project in the include list. In line 654, each of the project in the include list is inserted as a corresponding row (in table 500) with the bundle name (specified in text field 430) as the project name and the other details of the project (as depicted in rows 562-569 in table 500).

In row 655, a tool to generate the bundle of fixes is invoked. The invocation of the tool may be performed in any convenient/suitable manner as will be apparent to one skilled in the relevant arts. The execution of the code is stopped after line 655.

Thus, the software code of FIG. 6 on execution in combination with the status data of FIG. 5 causes the generation of a bundle from a list of fixes/projects specified as a group (as shown in FIG. 4), thereby simplifying bundling of fixes.

It should be appreciated that the above-described features of bundler tool 150 may be implemented in a combination of one or more of hardware, software, and firmware (though embodiments are described as being implemented in the form of software instructions). The description is continued with respect to an embodiment in which various features are operative by execution of corresponding software instructions.

### 8. Digital Processing System

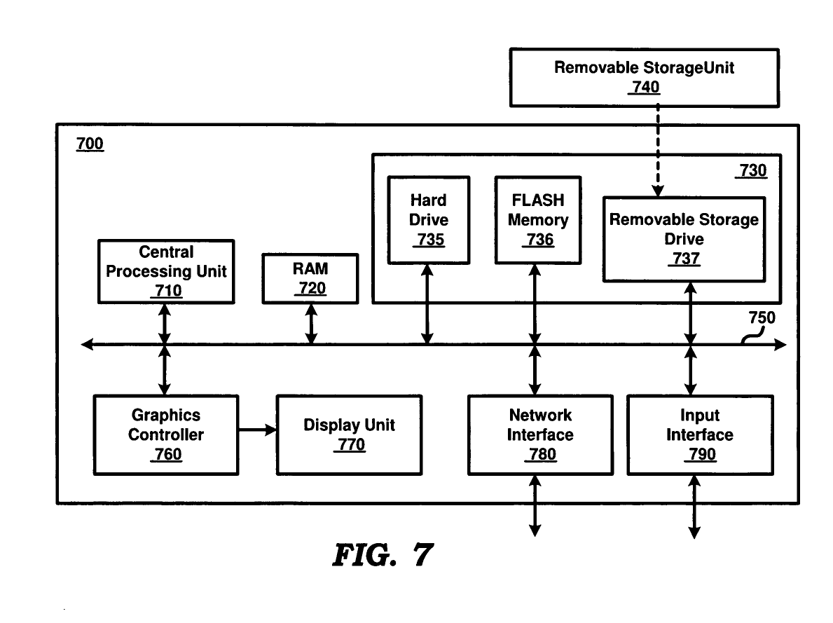

FIG. 7 is a block diagram illustrating the details of digital processing system 700 in which various aspects of the present invention are operative by execution of appropriate software instructions. Digital processing system 700 may correspond to any system (e.g., management system 170) executing bundler tool 150.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general-purpose processing unit. RAM 720 may receive instructions from secondary memory 730 using communication path 750.

Graphics controller 760 generates display signals (e.g., in RGB format) to display unit 770 based on data/instructions received from CPU 710. Display unit 770 contains a display screen to display the images (e.g., portions of screens depicted in FIG. 4) defined by the display signals. Input interface 790 may correspond to a keyboard and a pointing device (e.g., touch-pad, mouse) and may be used to provide inputs (e.g., those depicted in FIG. 4).

Network interface 780 provides connectivity to a network (e.g., using Internet Protocol), and may be used to communicate with other connected systems (such as client systems 110A-110B, runtime system 130, developer systems 160A-160B and database server 180) of FIG. 1.

Secondary memory 730 may contain hard drive 735, flash memory 736, and removable storage drive 737. Secondary memory 730 may store the data (e.g., portions of data depicted in FIG. 5) and software instructions, which enable digital processing system 700 to provide several features in accordance with the present invention.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present invention described above.

### 9. CONCLUSION

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way

What is claimed is:

1. A machine readable medium carrying one or more sequences of instructions causing a system to generate a bundle from a plurality of fixes, wherein each of said plurality of fixes is used to resolve one or more errors in a software pre-installed in a runtime system, wherein execution of said one or more sequences of instructions by one or more processors contained in said system causes said system to perform the actions of:
enabling a user to specify a list of fixes that are to be included in said bundle as a group, wherein said list of fixes is contained in said plurality of fixes;
determining whether each of said list of fixes is available; and
including in said bundle a first set of fixes, said first set of fixes being contained in said list of fixes and being determined to be available.

2. The machine readable medium of claim 1, further comprising one or more instructions for:
providing an indication to said user that a second set of fixes are not available, wherein said second set of fixes is contained in said list of fixes and are determined to be not available by said determining.

3. The machine readable medium of claim 2, further comprising one or more instructions for:
maintaining a status data indicating the availability of each of said plurality of fixes, wherein said determining determines the availability of each of said list of fixes based on said status data.

4. The machine readable medium of claim 3, wherein said user specifies said list of fixes in the form of a table containing a plurality of rows, wherein each row displays a corresponding one of said list of fixes, further comprising one or more instructions for:
displaying in each row whether the corresponding fix is available or not,
whereby said table indicates the specific ones of said first set of fixes and said second set of fixes.

5. The machine readable medium of claim 4, wherein said table is contained in a user interface displayed on a display screen, said enabling comprises:
receiving an identifier of each of said list of fixes in corresponding row of said table;
receiving an input representing a user selection of completion of providing said list of fixes,
wherein said determining is performed in response to receiving said input.

6. The machine readable medium of claim 4, wherein said enabling comprises receiving an identifier of a file from said user, said file containing identifiers corresponding to said list of fixes, further comprising one or more instructions for:
displaying said list of fixes in the form of said table.

7. The machine readable medium of claim 4, wherein said including is performed only if said first set of fixes is identical to said list of fixes.

8. The machine readable medium of claim 3, wherein said status data includes information related to a plurality of projects, wherein each project represents an implementation of a corresponding fix, wherein each project is identified by a corresponding project name, said project name containing the identifier of the corresponding fix, wherein said determining comprises:
checking whether the project name of each project contains the identifier of a fix; and
concluding the fix to be available if there is at least one project with project name containing the identifier of the fix and that the fix is not available if there is no project with the project name containing the identifier of the fix.

9. The machine readable medium of claim 8, wherein said status data is maintained in the form a table, wherein said including comprises:
inserting a project in the form of a corresponding row in said table for each of said first set of fixes, wherein the row contains a bundle identifier identifying said bundle and an object identifier of an object sought to be modified by said fix, whereby all of the inserted rows contain the same bundle identifier; and
invoking a tool which creates said bundle containing the objects corresponding to the rows having said bundle identifier in said table.

10. A method of generating a bundle from a plurality of fixes, wherein each of said plurality of fixes is used to resolve one or more errors in a software pre-installed in a runtime system, said method comprising:
maintaining a status data indicating the availability of each of said plurality of fixes;
enabling a user to specify a list of fixes that are to be included in said bundle as a group, wherein said list of fixes is contained in said plurality of fixes;
determining whether each of said list of fixes is available based on said status data;
including in said bundle said list of fixes if each of said list of fixes is determined to be available; and
otherwise providing an indication to said user the specific ones of said list of fixes that are determined to be not available.

11. The method of claim 10, wherein said user specifies said list of fixes in the form of a table containing a plurality of rows, wherein each row displays a corresponding one of said list of fixes, said method further comprising:
displaying in each row whether the corresponding fix is available or not.

12. The method of claim 11, wherein said table is contained in a user interface displayed on a display screen, wherein said enabling comprises:
receiving an identifier of each of said list of fixes in corresponding row of said table;
receiving an input representing a user selection of completion of providing said list of fixes,
wherein said determining is performed in response to receiving said input.

13. The method of claim 11, wherein said enabling comprises receiving an identifier of a file from said user, said file containing identifiers corresponding to said list of fixes, said method further comprising:
displaying said list of fixes in the form of said table.

14. The method of claim 10, wherein said status data includes information related to a plurality of projects, wherein each project represents an implementation of a corresponding fix, wherein each project is identified by a corresponding project name, said project name containing the identifier of the corresponding fix, wherein said determining comprises:
checking whether the project name of each project contains the identifier of a fix; and
concluding the fix to be available if there is at least one project with project name containing the identifier of the fix and that the fix is not available if there is no project with the project name containing the identifier of the fix.

15. The method of claim 14, wherein said status data is maintained in the form a table, wherein said including comprises:
inserting a project in the form of a corresponding row in said table for each of said first set of fixes, wherein the row contains a bundle identifier identifying said bundle and an object identifier of an object sought to be modified by said fix, whereby all of the inserted rows contain the same bundle identifier; and
invoking a tool which creates said bundle containing the objects corresponding to the rows having said bundle identifier in said table.

16. A computing system comprising:
a runtime system to execute a pre-installed software;
a data store to maintain a status data indicating the availability of each of a plurality of fixes, wherein each of said plurality of fixes is used to resolve one or more errors in said pre-installed software;
a bundler tool to generate a bundle from said plurality of fixes, said management system being operable to:
enable a user to specify a list of fixes that are to be included in said bundle as a group, wherein said list of fixes is contained in said plurality of fixes;
determine whether each of said list of fixes is available based on said status data;
include in said bundle said list of fixes if each of said list of fixes is determined to be available; and
otherwise provide an indication to said user the specific ones of said list of fixes that are determined to be not available.

17. The computing system of claim 16, wherein said user specifies said list of fixes in the form of a table containing a plurality of rows, wherein each row displays a corresponding one of said list of fixes, wherein said bundler tool displays in each row whether the corresponding fix is available or not.

18. The computing system of claim 11, wherein said table is contained in a user interface displayed on a display screen, wherein said bundler tool is designed to first receive an identifier of each of said list of fixes in a corresponding row of said table and then receive an input representing a user selection of completion of providing said list of fixes, wherein said bundler tool is designed to determine whether each of said list of fixes is available in response to receiving said input.

19. The computing system of claim 16, further comprising:
a plurality of developer systems to enable developers to develop a plurality of projects, wherein each project represents an implementation of a corresponding fix, wherein each project is identified by a corresponding project name, said project name containing the identifier of the corresponding fix,
wherein said status data includes information related to said plurality of projects,
wherein said bundler tool is designed to first check whether the project name of each project contains the identifier of a fix and then concludes the fix to be available if there is at least one project with project name containing the identifier of the fix and that the fix is not available if there is no project with the project name containing the identifier of the fix.

20. The computing system of claim 19, wherein said status data is maintained in the form a table in said data store, said computing system further comprising:
a tool to create said bundle containing the objects corresponding to the rows having a bundle identifier in said table, wherein said bundle identifier identifies said bundle sought to be generated,
wherein said bundler tool first inserts a project in the form of a corresponding row in said table for each of said list of fixes, wherein the row contains said bundle identifier and an object identifier of an object sought to be modified by said fix, whereby all of the inserted rows contain the same bundle identifier and then invokes said tool to cause said bundle containing said list of fixes to be generated.
